(19) United States
(12) Patent Application Publication
(10) Pub. No.: US 2012/0020751 A1
(43) Pub. Date: Jan. 26, 2012

(54) Multi-directionally fluted rotary cutting tool

(76) Inventor: Suneel Bhaskar Bhat, Clarksville, MD (US)

(21) Appl. No.: 12/804,495

(22) Filed: Jul. 23, 2010

(51) Int. Cl. B23B 51/02

(52) U.S. Cl. 408/230

(57) ABSTRACT

A rotary cutting tool having a longitudinal body with a rotational axis, comprising a proximal aspect allowing for insertion into an unmotorized or motorized drill, a distal aspect with one or more cutting edges, and two or more fluted segments, among which at least two orientations of fluting are present. A plurality of spacing, shaping, or surfacing may be present between the cutting edge and fluted segments or between fluted segments, and the diameter of the cutting edge may be different than a given point between the distal and proximal aspects of the device.

### CROSS-REFERENCE TO RELATED APPLICATIONS

not applicable

### STATEMENT REGARDING FEDERALLY SPONSORED RESEARCH OR DEVELOPMENT

not applicable

### REFERENCE TO SEQUENCE LISTING, A TABLE, OR A COMPUTER PROGRAM LISTING COMPACT DISC APPENDIX

not applicable

### BACKGROUND OF THE INVENTION

The creation of holes or apertures in a material is an important mechanical function in a number of materials, including but not limited to bone, teeth, wood, metal, plastics, polymers, and composites, and is often is' used to facilitate insertion of screws or other fixation devices. Many devices used to create these holes or apertures comprise a cutting edge at the end of a longitudinal body serving as a rotational axis. These devices primarily maximize the cutting and excision of material with creation of the hole or aperture, and the utilization of fluting has improved the removal of material from the hole or aperture. The volume of material excised from a hole or aperture is usually equal or greater to the diameter of the device by the depth into the material cut; i.e. the volume of the material excised and removed is equal or greater to the dimensions of the hole or aperture created.

In some materials, purchase of screws or other fixation devices is dependent on material stock at the screw/fixation device and material interface. Particularly in less dense or porous materials, e.g. ostoporotic bone or soft wood, maximal efficient cutting, excision, and removal of material results in decreased purchase of screws and fixation devices; reducing strength and longevity of fixation.

Preservation of material stock with creation of a hole or aperture may lead to improved purchase of screws and other fixation devices. Improved purchase of screws and fixation devices would lead to improved strength and longevity of fixation, leading to reduced rates of device failure and breakage. For the forgoing reasons, there is an acute need for a device that effectively creates a hole or aperture, while cutting and excising a volume of material less than that of the hole or aperture, creating a greater interface for fixation devices, or that maximizes the preservation of material stock in material where a hole or aperture is created.

### SUMMARY

The present invention is directed to an article of manufacture that addresses these needs. The article of manufacture comprises a longitudinal body with a rotational axis, with a proximal aspect with a shank allowing for insertion and securing into a drill, a distal aspect with one or more cutting edge, and more than one segment of fluting between the distal and proximal aspects, where there are at least two different directions, e.g. clock-wise as viewed from the distal-most aspect, counter-clockwise as viewed from the distal-most aspect, or neutral as viewed from the distal-most aspect, represented among the segments of fluting. Furthermore, the article of manufacture may have any number of spacings, shapings, or surfaces, in between the cutting edge and fluted segments and in between fluted segments. Furthermore the article of manufacture may have a diameter between the distal and proximal aspects different than that of the cutting edge, e.g. a gradual increase in diameter between the cutting edge and given a point between the distal and proximal aspects.

The present invention when used to create a hole or aperture in material, especially in soft or porous material, will create a hole or aperture in which the volume of material cut and excised will be less than the volume of the hole or aperture created. This is achieved with initial cutting and excision of material by rotation of the cutting edge at the distal aspect, and early clearance by fluting preferably oriented in the same direction relative to the distal aspect as the cutting edges, adjacent or close to the distal aspect. As creation of the hole or aperture proceeds, the material will come in contact with land surfaces in the more proximal segment of fluting, which is in a different orientation than the cutting edge or more distal fluting, and will result in compaction of material at the material device interface, along with removal of free debris.

The compaction of material at the edge of hole or aperture created, which is maximized superficially, is facilitated by a cutting edge diameter smaller than the desired hole or aperture, with a gradual increase to the desired diameter at or proximal to the segment of differently oriented lands and fluting. Compaction of material into the walls of the hole or aperture with its creation results in preservation of material stock, and results in the volume excised being less than that of the hole or aperture created.

Compaction of material, especially in the superficial aspects, of a created hole or aperture allows for greater purchase of screws or other fixation devices, especially in material that is non-homogenous with superficial aspects contributing greater to fixation, e.g. bone and teeth. Use of the, present invention to generate holes or apertures allowing greater purchase of screws and other fixation devices in the material, due to compaction and preservation of material stock, increases the strength and reduces the failure rate of fixation. These and other features, aspects, and advantages of the present invention will become better understood with reference to the following description and claims.

### BRIEF DESCRIPTION OF THE DRAWINGS

FIG. 1 shows a lateral view of one embodiment of the described invention.

FIG. 2 shows a lateral view of the embodiment of the described invention depicted in FIG. 1 rotated 90°.

FIG. 3 shows an alternative embodiment of the described invention,

FIG. 4 shows an end-on view of one embodiment of the described invention as seen from the distal aspect.

### DESCRIPTION OF THE PREFERRED EMBODIMENT

It should be understood that like reference numerals are intended to identify the same structural elements, portions, or surfaces consistently throughout the several figures, as such elements, portions, or surfaces may be further described or explained by the entire written specification, of which this detailed description is an integral part. Unless otherwise specified, the drawings are intended to be read together with the specification, and are considered a portion of the entire “written description” of this invention, as required by 35 U.S.C. §112.

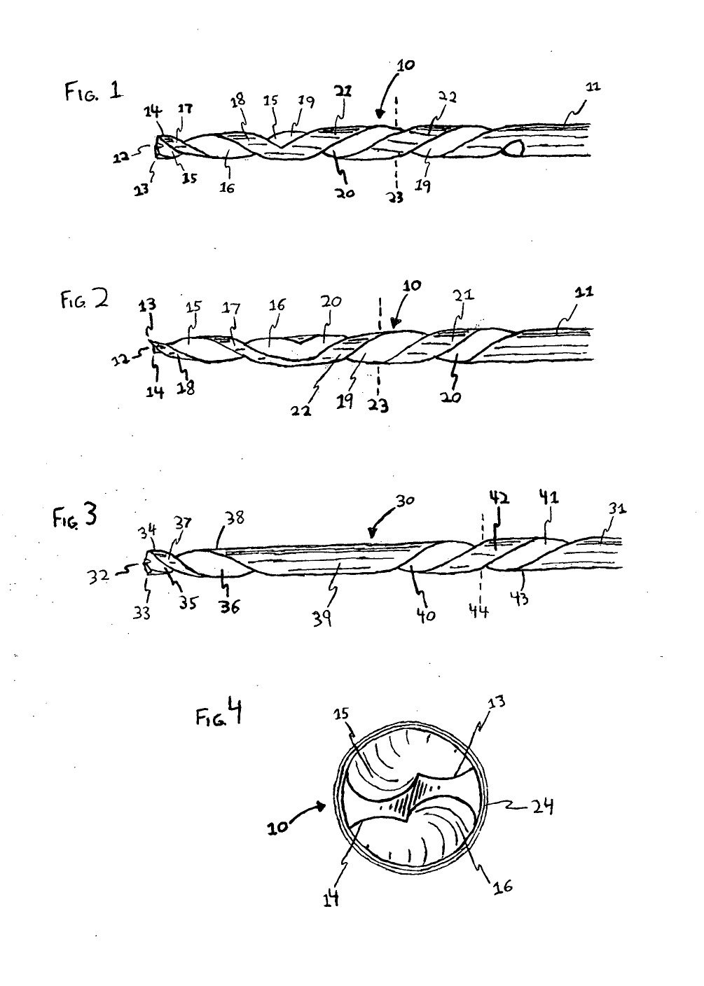

Referring to the drawings, a device indicated generally at 10 according to the preferred embodiment of the invention is depicted in FIG. 1. It has a proximal aspect comprising a shaft 11 that is suitable for insertion into an unmotorized or motorized drill, and a distal aspect with a point 12, and cutting edges 13 and 14 suitable for cutting material when rotated counter-clockwise from the perspective of the point 12. Helical flutes 15 and 16 and helical lands 17 and 18 originate from the cutting edges and spiral in a clockwise direction from the perspective of the point 12 proximally towards the proximal aspect of 10, forming the most distal segment of fluting. Helical flutes 19 and 20 and helical lands 21 and 22 spiral in a counter-clockwise direction from the perspective of point 12 proximally towards the proximal aspect of 10 forming the most proximal segment of fluting. Helical flute 19 originates from helical flute 15 and helical flute 20 originates from helical flute 16, while helical land 21 originates from helical land 18 and helical land 22 originates from helical land 17. Helical lands 17, 18, 21, and 22 all gradually increase in diameter proximally from the cutting edges 14 and 15 to 23, a point within the section of fluting formed by helical flutes 19 and 20 and helical lands 21 and 22. The diameter of helical lands 21 and 22 proximal to 23 and shank 11 is constant.

When utilized for soft or porous material, for example osteoporotic bone, with for example a diameter of 2.5 millimeters at the cutting edges 13 and 14 and a diameter of 3.2 millimeters at point 23 and proximally, a hole or aperture would be created where the volume of material excised would be less than the volume of the hole or aperture created, where material would be compacted into the walls of the hole or aperture created, allowing for greater purchase of screws or other fixation devices. With rotation of 10, point 12 and cutting edges 13 and 14 would cut and excise material. With deepening of the hole or aperture, lands 17 and 18 would promote cutting of material at a diameter less than that of the final desired diameter, while flutes 15 and 16 would remove excised debris material proximally. With continued deepening of the hole or aperture, lands 21 and 22, oriented in a direction different to that of lands 17 and 18 and with a diameter progressively greater more proximally, would not excise material, but compress and compact material into the walls of the hole or aperture being created, reducing the volume that an equivalent mass of material composed. The material exposed to lands 17 and 18 proximal to point 23, the area of which would increase superficial to deep with deepening of the hole or aperture, would have a more dense and compact structure along the walls of the hole or aperture—superficial aspects of the hole or aperture exposed to lands 17 and 18 proximal to point 23 would be at the desired final diameter. For example with osteoporotic cortical bone, the microscopic structure of the bone would be more compact and dense, which allows for greater purchase of screws and fixation devices.

FIG. 2 illustrates the same embodiment 10 depicted in FIG. 1, rotated 90°. FIG. 4 illustrates the same embodiment 10 depicted in FIG. 1 and FIG. 2, from the perspective of the distal aspect, point 12, where proximal lands 18, 21, and 22 and the shank 11 all of greater diameter than the cutting edges 13 and 14 are represented by 24.

A device indicated generally at 30 according to an alternative embodiment of the invention is depicted in FIG. 3. Like 10 it has a proximal aspect comprising a shaft 31 that is suitable for insertion into an unmotorized or motorized drill, and a distal aspect with a point 32, and cutting edges 13 and 14 suitable for cutting material when rotated counter-clockwise from the perspective of the point 12. Helical flutes 35 and 36 and helical lands 37 and 38 originate from the cutting edges and spiral in a clockwise direction from the perspective of the point 32 proximally towards the proximal aspect of 30, forming the most distal segment of fluting. Helical flutes 35 and 36 and helical lands 37 and 38 terminate in a solid section with out fluting 39. Helical flutes 40 and 41 and helical lands 42 and 43 spiral in a counter-clockwise direction from the perspective of point 32 proximally towards the proximal aspect of 30 forming the most proximal segment of fluting. Helical flutes 40 and 41 and helical lands 42 and 43 originate from unfluted segment 39. Helical lands 37 and 38, unfluted segment 39, and helical lands 42 and 43 gradually increase in diameter proximally from the cutting edges 34 and 35 to 44, a point within the section of fluting formed by helical flutes 40 and 41 and helical lands 42 and 43. The diameter of helical lands 42 and 43 proximal to 44 and shank 31 is constant.

Although the present invention has been described in considerable detail with reference to certain preferred versions thereof, other versions are possible. Therefore, the spirit and scope of the appended claims should not be limited to the description of the preferred versions contained therein. Any element in a claim that does not explicitly state “means for” performing a specified function, or “step for” performing a specified function, is not to be interpreted as a “means” or “step” clause as specified in 35 U.S.C. §112, ¶6. In particular, the use of “step of” in the claims is not intended to invoke the provisions of 35 U.S.C. §112, ¶6.

I claim:

1. A device having a longitudinal body with a rotational axis, said device comprising:
a proximal aspect with a shank allowing for insertion and securing into an unmotorized or motorized drill;
a distal aspect with one or more cutting edges arranged to cut material when rotated; and
two or more segments between the distal and proximal aspects each comprising:
one or more helical or straight flutes
whereby at least two of said fluted segments have different flute orientations (e.g. clock-wise as viewed from the distal-most aspect, counter-clockwise as viewed from the distal-most aspect, or neutral as viewed from the distal-most aspect).

2. A device according to claim 1 wherein there is a plurality of spacing, shaping, and surfacing between the cutting edge and the most distal segment of fluting, and between each segment of fluting between the distal and proximal aspects of the device.

3. A device according to claim 2 wherein the diameter of the cutting edge is different than the diameter of a given point between the distal and, proximal aspects of the device.
